(19) United States
(12) Patent Application Publication
(10) Pub. No.: US 2016/0247193 A1
(43) Pub. Date: Aug. 25, 2016

(54) SYSTEM AND METHOD OF DYNAMICALLY TARGETING INFORMATION TO PRODUCT USERS

(71) Applicant: TROY GROUP, INC., Costa Mesa, CA (US)

(72) Inventors: David Altfeder, Aberdeen, NC (US); Jason Drew Peek, Pinehurst, NC (US)

(21) Appl. No.: 14/802,834

(22) Filed: Jul. 17, 2015

Related U.S. Application Data
(60) Provisional application No. 62/118,221, filed on Feb. 19, 2015.

(51) Int. Cl. G06Q 30/02; H04L 29/08

(52) U.S. Cl. CPC G06Q 30/0255; H04L 67/02; H04L 67/306; G06Q 30/0277

(57) ABSTRACT

A computer-based system and method are provided for targeting advertisement to a user of a product based on interests of the user. The system includes a first computer-based device that operates a rule-defining software for receiving rule-defining data. A web server stores rules in a database based on the rule-defining data. A second computer-based device detects a product identifier and operates a web browser for displaying a webpage based on the product identifier. The web server determines product data based on the product identifier and retrieves or determines user interest data corresponding to interests of the user. The web server applies one or more of the stored rules to the product data and the user interest data, and modifies at least a page part of the webpage.

### CROSS REFERENCE TO RELATED APPLICATIONS

This application claims the benefit of U.S. provisional patent application Ser. No. 62/118,221 filed on Feb. 19, 2015 and titled “System an Method of Providing Marketing Information to Consumer Based on Product Scan,” which is incorporated in this application as if fully set forth herein.

### BACKGROUND OF THE INVENTION

1. Field of the Invention

The present invention relates to computer-based methods and systems for advertising products or services to users of computer-based devices.

2. Description of Related Art

As a result of the recent surge in use of smart portable electronic devices (such as iPhones or iPads) and online platforms, brand owners have sought to utilize such devices and platforms to convey information about their products or services to users. The information is often displayed on a website that can be accessed at a unique address, referred to as a Uniform Resource Locator (URL). The URL is encoded in a Quick Response (QR) Code® printed on a label of the product or its package. A user of the product captures an image of the QR code using a camera of a computer-based portable electronic device (such as an iPhone® or iPad®). The portable electronic device operates a code-scanning software that decodes the QR code to retrieve the URL. The code-scanning software sends the URL to a web browser of the portable electronic device. The web browser displays the website for the user.

The websites known in the art are predetermined and static in that the same information is displayed to different users. For example, coupons, directions for use, warnings, disclaimers, or warranty information that are common for all users are displayed on the website. A shortcoming of this model is that the brand owner is unable to learn information about the user and target advertisement information to users based on their particular needs and interests.

There is a need in the art for a dynamic computer-based method and system for learning information about the user and utilizing the learned information to target advertisement to the users based on their needs, location, or other characteristics.

### SUMMARY OF THE INVENTION

The invention is a computer-based method and a system for delivering targeted information to a user of a product or service. The targeted information can be advertisement contents that are displayed on a computer-based device of a user (such as a tablet computer or a smart phone). The advertisement contents are dynamic in that they vary from one user to another. The system provides a brand owner effective tools to define and customize rules for targeting advertisement contents to a user based on his/her demographics, location, and various other attributes. The system learns and/or retrieves information about the location, demographics, and/or interests of the user and delivers advertisement contents based on the information.

In one embodiment, the system includes a first computer-based device that operates a rule-defining software. The rule-defining software stores rules in the database based on rule-defining data received from a brand owner. The rule-defining data vary advertisement contents based on the product type, product lot, or unique identification code of the product. The rule-defining data is further based on demographics or interests of a user, location of a user, and/or a time period for advertisement.

The user operates a second computer-based device such as a portable electronic device to detect a product identifier that encodes a webpage locator and product data. A web browser on the portable electronic device displays a webpage corresponding to the webpage locator. The webpage has one or more page parts that are dynamically determined by a web server. The web server decodes the product data which includes a product identification code, a lot identification code, and a unique identification code associated with the given instance of the product.

In an alternative embodiment, a label ID and a serial number (unique identification code) can be generated for a product and encoded in the QR code. The label ID is associated with a product identification code and a lot identification code in the database. The web server can retrieve the associated product identification code and lot identification code based on the scanned and decoded label ID.

The system further learns or retrieves information about demographics, location, and interests of the user. The first time that the user scans the QR code, the system stores a user-tracking code such as a cookie on the portable electronic device. The cookie allows the portable electronic device and the web server to track activities of the user in order to enrich data learned about the user's interests and activities. Enriching the data learned about the user enhances ability of the system to target advertisement contents to the intended user.

The system applies one or more rules (defined using the brand owner's input) to the product data, user demographics, and interests, and location. For example, a brand owner can specify that advertisement contents be delivered to users of a given product with a defined set of interests and certain age and gender in a certain geographical area for a defined period of time. Therefore, the system and method of the present invention provide effective software tools for a brand owner to define and customize advertisement contents and manner of delivering the contents.

### BRIEF DESCRIPTION OF THE DRAWINGS

The exact nature of this invention, as well as the objects and advantages thereof, will become readily apparent upon consideration of the following specification in conjunction with the accompanying drawings in which like reference numerals designate like parts throughout the figures thereof and wherein:

FIG. 1 is a block diagram illustrating hardware components of a computer-based system for delivering targeted information to a product user;

FIG. 2 is a block diagram illustrating software components operated by respective hardware components shown in FIG. 1;

FIG. 3 is a flow diagram showing a computer-based method of storing rules based on brand owner input;

FIG. 4 is a screenshot of user interface of a rule-defining software;

FIGS. 5A and 5B collectively show a flow diagram of a method of delivering targeted information based on rules defined using the method shown in FIG. 3; and

FIG. 6 is a flow diagram showing a method of providing targeted information based on interests and location of a product user.

### DETAILED DESCRIPTION OF THE PREFERRED EMBODIMENTS

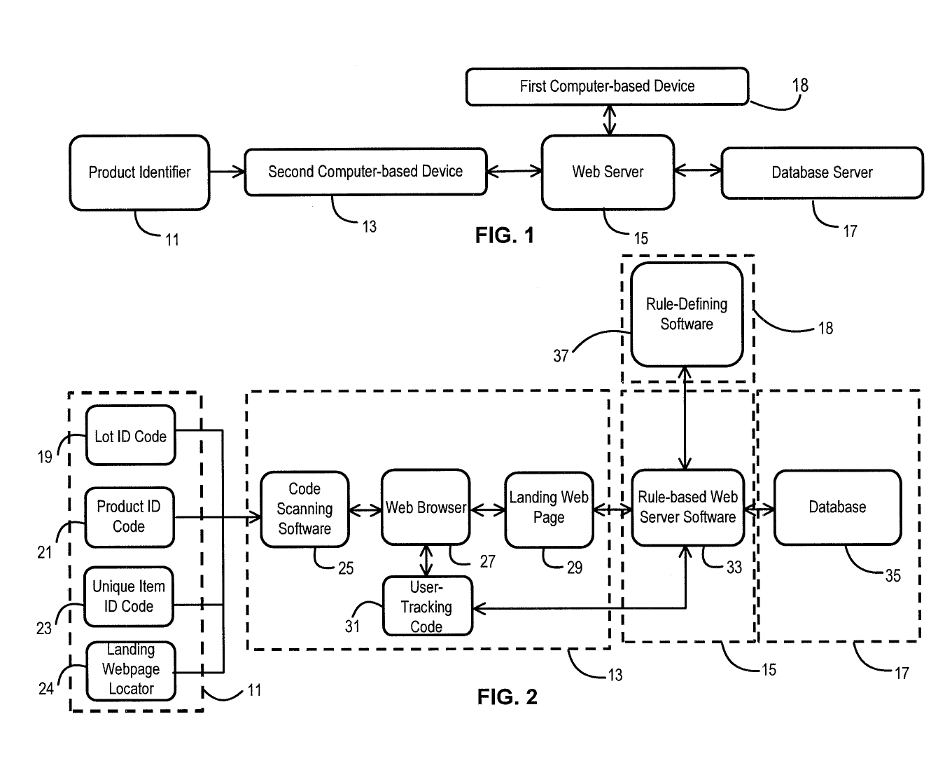

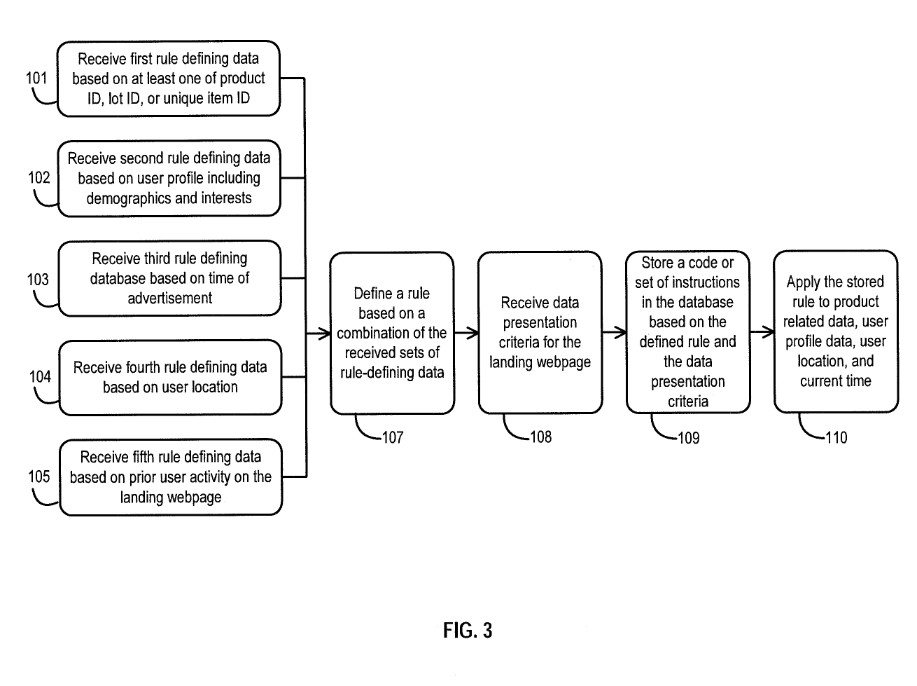

FIG. 1 shows hardware components of a computer-based system for providing targeted information to a user of a product or service according to an embodiment of the invention. FIG. 2 is a block diagram illustrating software components of the system. The system includes a first computer-based device 18 for operating a rule-defining software 37. The rule-defining software 37 allows a brand owner to define contents of advertisement or other information delivered to the user of a second computer-based device 13. The rule-defining software 37 further allows the brand owner to define the way the advertisement is presented to the user. A brand owner as used hereinafter refers to an individual who defines advertisement contents and manner of delivering the contents to users for certain products or services.

The first computer-based device 18 is connected to a web server 15. The double-headed arrows in FIGS. 1 and 2 denote two-way communications between the illustrated blocks. The communication can be via any wired or wireless communication network such as a cloud-based or Internet connection. The web server 15 operates a rule-based web server software 33 that stores rules in the database 35 (operated by a database server 17). The rule-based web server software 33 stores rules based on rule-defining data provided by the first computer-based device 18.

The web server 15 is also selectively connected to the second computer-based device 13. The second computer-based device 13 can be a variety of computer-based devices having a processor capable of operating a web browser and a code detection software. In an embodiment, the second computer-based device 13 is a portable electronic device such as a smart cellphone (e.g., an iPhone) or a portable tablet computer-based device (e.g., an iPad). The second computer-based device 13 has at least a processor, a local memory, and a camera.

The connection between the second computer-based device 13 and the web server 15 is established in response to identification of a product identifier 11 by the second computer-based device 13. In one embodiment, the product identifier 11 corresponds to a code such as QR code printed on a product label or package. In an embodiment, the product identifier is. The product identifier 11 encrypts a lot identification code 19, a product identification code 21, and a unique item identification code 23.

The product identifier 11 further encrypts a landing webpage locator 24 (e.g., a URL for the landing webpage). Although examples of encryption in a QR code are described hereinafter, other product identifiers would be compatible with the system and method according to the invention. Alternatively, other types of detectable identification codes or images such as a Universal Product Code (UPC) or a watermark can encode items 19, 21, 23 and 24. In another alternative embodiment, an image recognition software can recognize a product using its image or a logo associated with the product.

The product identifier 11 described above utilizes image recognition. Alternatively, the product identifier 11 can be a wireless communication chip that transmits the information (for example, items 19, 21, 23 and 24) to the second computer-based device 13 without scanning or image recognition. For example, the product identifier 11 can be a radio-frequency identification (RFID) tag or a near field communication (NFC) tag that wirelessly transmits the items 19, 21, 23 and 24 to an antenna or receiver of the second computer-based device 13. In such embodiments, the code scanning software 25 can be replaced with a decoding software that decodes the wireless signals received from the RFID tag or NFC tag to retrieve the information (for example, items 19, 21, 23 and 24).

The second computer-based device 13 operates a web browser 27 that retrieves a landing webpage 29 based on the landing webpage locator 24 (e.g., URL). A “landing webpage” as used herein refers to a webpage displayed on the second computer-based device 13 and having dynamic information content determined by the web server 15. The landing webpage 29 can be an HTML-based (Hyper Text Markup Language) webpage. The rule-based web server software 33 dynamically controls contents of the landing webpage 29.

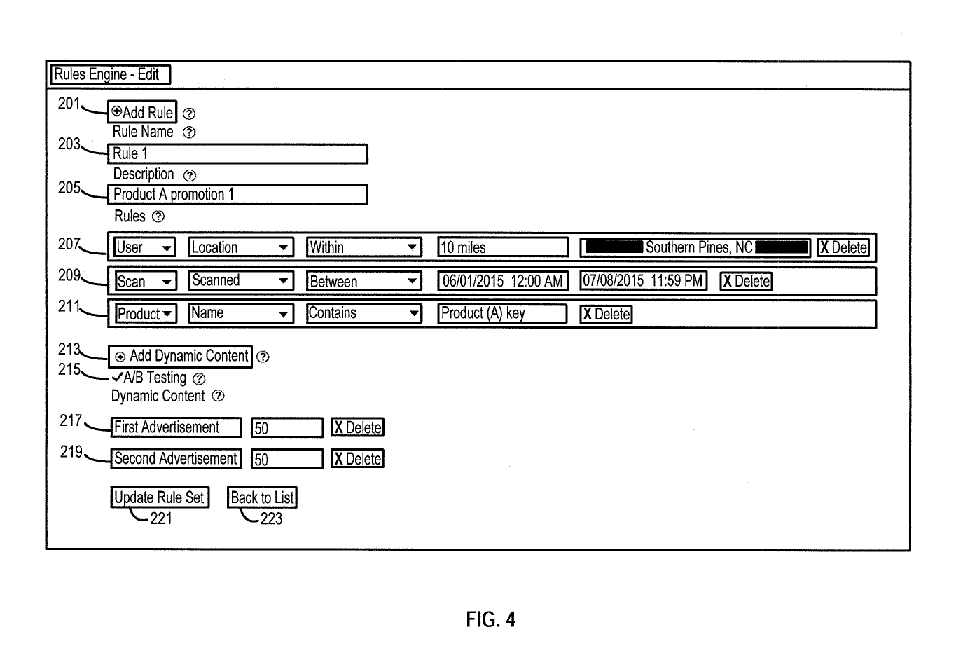

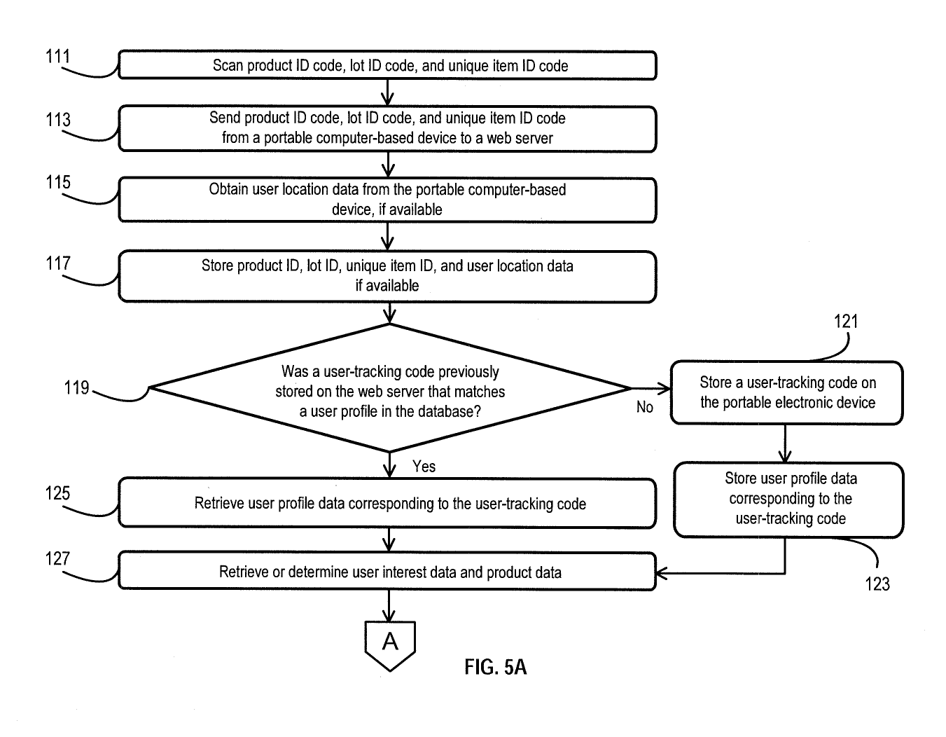

The rule-based web server software 33 stores rules based on rule-defining data received from the rule-defining software 37, as described in further details below with respect to FIGS. 3 and 4. The rule-based web server software 33 applies one or more of the stored rules to the product data and data learned about the user. The web server software 33 determines contents of page parts of the landing webpage 29 based on the application of the rules.

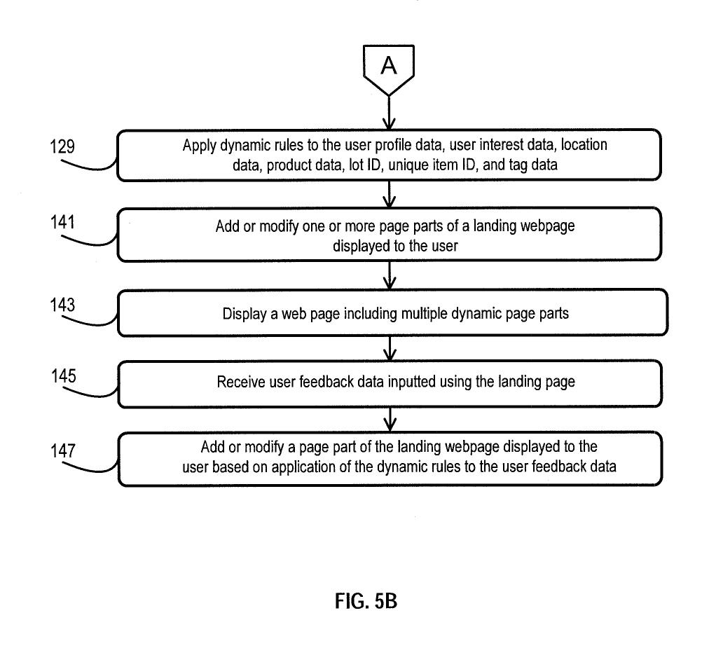

The rule-based web server software 33 or another software of the web server 15 stores a user-tracking code 31 on the second computer-based device 13 to track certain activities of the user on the second computer-based device 13. The user-tracking code 31 can be a cookie that includes electronic messages transmitted between the web browser 27 and the web server 15 about the user's activities. For example, the cookie allows the web server 15 to identify the user and track and learn his/her browsing activity and interests. For example, if the user identifies himself/herself by logging in, registering the product online, providing feedback regarding the product, or completing a product survey, then the received information is tracked and communicated to the web server 15. The web server software 33 enriches data learned about the user using the tracked activities such as web browsing activities, as discussed in further detail below with respect to FIGS. 5A and 5B. The user-tracking codes 31 enrich the data learned about the user, which in turn enhances ability of the system to target advertisement contents to the intended user.

FIG. 3 shows a method of storing or updating rules in the database based on rule-defining data provided by a brand owner. In steps 101-105, the web server 15 receives rule-defining data from a rule-defining software 37 or a rule-defining website.

In step 101, the rule-defining software 37 receives first rule-defining data based on at least one of the lot identification code 19, product identification code 21, and unique item identification code 23.

The lot identification code 19 refers to a particular lot or group of products shipped from a manufacturer or distributor. Lot identification allows a brand owner to deliver information about a group of products with a common characteristic or issue. For example, if a brand owner learns that a certain lot of shipped food products included rotten products, the brand owner can convey warning information to users who scan or detect a product identifier 11 that encodes the lot identification code 19 associated with the problematic lot.

The product identification code 21 is assigned to a product model or type (e.g., a particular model and year of laptop computer). The product identification code 21 is helpful for targeting advertisement based on the product type. The first rule-defining data can utilize a database of complementary products to offer promotions relevant to the product identification code 21. Certain product ID codes can be correlated with one another in the database 35 as being complementary products. For example, a soccer goalkeeper outfit and goalkeeping gloves can be stored as being complementary. The first rule-defining data can request outputting advertisement regarding products that are on sale and complementary to a previously purchased product by referring to respective product identification codes 21. In the above example, after a user purchases a goalkeeper outfit and scans a corresponding QR code, the system automatically outputs advertisement related to goalkeeping gloves that are on sale, as defined by the first rule-defining data.

The unique item identification code 23 is a unique code assigned to each instance of a product. For example, the unique item identification code 23 is a GUID (Globally Unique Identifier) or a UUID (Universally Unique Identifier). Two instances of the same model of a product have distinct unique item identification codes 23. This allows unique identification of each instance of a product, for example, to allow user registration of the product. User registration allows the system to receive user information that is entered during the registration and track his or her activities.

In step 102, the rule-defining software 37 receives second rule-defining data based on user profile which can be based on demographics such as age and gender. Furthermore, the second-rule defining data can be based on user interests and previously scanned products indicative of prior product purchases. For example, a brand owner of race car products can define rules that would direct its advertisement to users with interest in racing and/or having certain demographic characteristics that are shown to be statistically correlated with interest in racing.

In step 103, the rule-defining software 37 receives third rule-defining data based on time (for example, time of scan or current time). The brand owner can specify the time period for displaying a promotional offer. For example, the brand owner can require delivering certain Easter holiday promotions during a certain time period before the Easter holiday. This eliminates the need for the brand owner to log in and manually withdraw an advertisement after the Easter holiday has passed.

In step 104, the rule-defining software 37 receives fourth rule-defining data based on user location retrieved from the second computer-based device 13. For example, the rule-defining data can request determination of the following condition: whether a user with an interest in soccer is within a certain threshold distance (e.g., 20 miles) of certain defined stores offering soccer goods. The rule-defining data can further require delivering advertisement content regarding soccer goods offered at the nearby store if the condition is met.

In step 105, the rule-defining software 37 receives fifth rule-defining data based on prior user activity on the landing webpage 29. This includes information regarding items on the landing webpage 29 that the user viewed or selected by clicking or tapping. The prior activity can be indicative of user interests or purchasing tendencies. The brand owner can further select to output different advertisement contents based on the number of times that a user previously visited the landing webpage 29. The brand owner can vary the information delivered to the user based on his or her prior activity.

In step 107, the web server 15 stores or updates rules in the database 35 based on a combination of the received sets of rule-defining data. The rule-defining data listed in steps 101-105 is not exhaustive. The rule-defining software 37 can define the rules based on other criteria. The brand owner can further indicate Boolean logic relationships between the defined criteria. For example, the input can indicate that certain advertisement be outputted if all or a majority of the criteria are met.

In step 108, the web server 15 receives data presentation criteria from a rule-defining software 37. The data presentation criteria can indicate the type of information outputted (e.g., image, video, text, voice), the positioning of the information on the landing webpage, or other criteria for conveying advertisement information to the user.

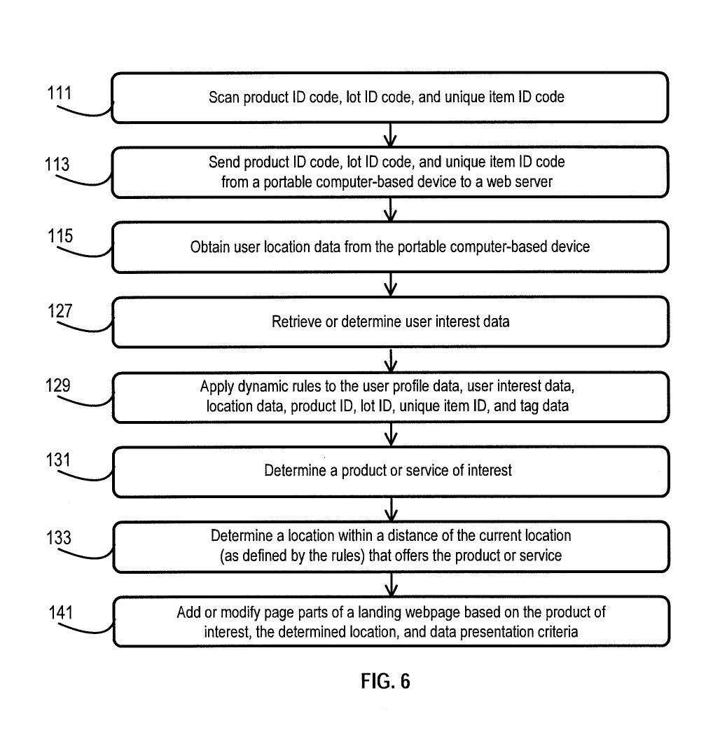

In step 108, a code or set of instructions are stored in the database based on the defined rule and the data presentation criteria. In step 110, the rule-based web server software 33 applies the stored rules to profile data (information learned about the user), product data, time data, and the user's location, as described below with respect to FIGS. 5A, 5B and 6.

FIG. 4 is a screenshot of the user interface of the rule-defining software 37. After logging into the rule-defining software 37, a brand owner can modify advertisement content delivery for products with product identification codes assigned to the brand owner in the database 35. The brand owner can add a rule using button 201. The rule name and description of the rule are inputted in fields 203 and 205, respectively. The drop down boxes and text fields in row 207 allow the brand owner to modify rules based on the location of the user, as described above with respect to step 104 of FIG. 3. In the example shown in FIG. 4, the rule specifies that the content be displayed for users within 10 miles of a defined location. The drop down boxes and text fields in row 209 allow the brand owner to specify the time period that the QR code is scanned, as described above with respect to step 103 of FIG. 3.

The drop down boxes and text fields in row 211 allow the brand owner to modify rules based on the product data. In the example shown in FIG. 4, the rule specifies that the content be displayed for scanned products that have certain keyword in their product name. The system recognizes product identification codes 21 that correspond to product names with the inputted keyword and associates the defined rules with such codes. Button 213 allows the brand owner to add dynamic advertisement content based on the specified criteria.

The brand owner can further specify the data presentation criteria as described above with respect to step 108 of FIG. 3. Checkmark 215 activates “A/B testing” of two different specified advertisements 217 and 219. The first advertisement 217 is displayed to 50% of users that scan a product and meet the criteria of the defined rule, and the second advertisement 219 is displayed to the other 50% of users. The system compares how users respond to the two advertisements.

For example, the system collects first advertisement data indicating the ratio of users that selected the first advertisement 217 (by clicking or tapping) over the users that viewed a landing webpage having the first advertisement 217. The system also collects second advertisements data indicating the ratio of users that selected the second advertisement 219 over the users that viewed a landing webpage having the second advertisement 219. This will allow the brand owner to determine the effectiveness of an advertisement by having a benchmark for comparison. If the difference is statistically significant, the brand owner would proceed with one of the first and second advertisements associated with the better performance. Alternatively, the first and second advertisements can be displayed side-by-side on a single landing webpage. The feedback data can indicate which advertisement the users preferred (as indicated for example by comparing the number of clicks/taps on the advertisements). Button 221 allows the brand owner to update the rule once done with the edits. Button 223 allows the brand owner to return back to a list of rules to modify other rules, if desired.

FIGS. 5A and 5B collectively show a method of providing targeted information to a user of a product or service based on interests of the user. In step 111, the user scans a product identifier 11 embedding product ID code 21, lot ID code 19, and unique item ID code 23 using the code scanning software 25. In step 113, the code scanning software 25 sends the product ID code 21, lot ID code 19, and unique item ID code 23 from the second computer-based device 13 (e.g., a portable computer-based device) to the web server 15. In step 115, the web server 15 obtains user location data from the portable computer-based device, if available. In step 117, product ID code 21, lot ID code 19, unique item ID code 23, and user location data (if available) are stored in the database 35.

In an alternative embodiment, a label ID and a serial number (unique identification code) can be generated for a product and encoded in the QR code. The label ID is associated with a product identification code 21 and a lot identification code 19 in the database 35. The web server 15 can retrieve the associated product identification code and lot identification code based on the scanned and decoded label ID.

In step 119, the web server 15 determines whether a user-tracking code (e.g., a cookie) was previously stored on the portable electronic device that matches a user profile in the database 35. If so, the web server 15 retrieves user profile data corresponding to the user-tracking code.

If a user-tracking code was not previously stored, the web server 15 stores a user-tracking code (e.g., a cookie) on the second computer-based device 13 (e.g., portable electronic device), as shown in step 121. In step 123, the web server 15 stores user profile data corresponding to the user-tracking code. For example, a new database record with a new user ID can be created for the consumer of the product. This allows tracking future activities of the user and utilizing previously stored information about the user in targeted advertising.

In step 125, the rule-based web server software 33 retrieves user profile data corresponding to the user-tracking code. The user profile data can indicate demographics (such as age and gender), interests, corresponding purchased products, previous visited locations, and various other collected information about the user.

In step 127, the web server software 33 retrieves or determines user interest data and product data. The web server software 33 retrieves this information from the database 35. If the information stored in the database regarding the user is limited, the rule-based web server software 33 can retrieve or determine user demographics and interests by accessing information about the user stored in external databases (for example, Google® Analytics database).

In step 129, the web server 15 applies the dynamic rules to the user profile data, user interest data, location data, product identification code, lot ID, and unique item ID. The applied rules are defined by the brand owner as described above with respect to FIGS. 3 and 4. The web server 15 determines whether any of the stored rules have conditions that match the retrieved data. An example of an application of the rules is described below with respect to FIG. 6.

In step 141, the web server 15 adds or modifies one or more page parts of a landing webpage displayed to the user. For example, the page parts include the dynamic advertisement contents defined by the A/B testing fields as described above with respect to items 213-219 of FIG. 4. In step 143, the second computer-based device 13 displays the landing webpage 29 including multiple dynamic page parts that are defined by the rules and information learned about the user. Page parts include text, hyperlinks, images, rich text (formatted text), audio and/or video.

In step 145, the web server 15 receives user feedback data inputted using the landing webpage 29. For example, the user can provide feedback by tapping or clicking on a displayed advertisement item such as a button. The feedback is stored in the database 35 and associated with the user ID . . . .

The system can further prepare electronic reports useful for the brand owner in assessing the effectiveness of the advertisement. For example, the reports can indicate the A/B testing feedback described above with respect to FIG. 4, total number of landing webpage views, average duration of a session during which the user is on the landing webpage, and location map of scans of the product identifier 11.

In step 147, the web server 15 adds or modifies a page part of the landing webpage 29 or links to a new webpage based on application of the dynamic rules to the user feedback data. In other words, the rules can indicate the material to be displayed in response to a user selection of a button or item on the displayed page part.

FIG. 6 shows an example of the method described above with respect to FIG. 5. Steps 111, 113, 115, 127 and 129 are performed as described above. In step 131, the web server 15 determines a product or service of interest for the user. In the example described above with respect to FIG. 3, the web server 15 determines that the user is interested in soccer, and he has previously purchased a goalkeeper outfit categorized as a complementary product of goalkeeping gloves.

In step 133, the web server 15 determines a store within a distance of the current location (e.g., 20 miles as defined by the rules) that offers the product or service. The list of stores can be defined by the brand owner using the rule-defining software 37. In step 141, the web server 15 adds or modifies one or more page parts of the landing webpage 29 displayed to the user to deliver the advertisement contents.

Therefore, the system and method described herein provides tools for brand owners to learn information about users of their products and services. The system and method further provide effective tools for the brand owner to utilize the learned information to effectively target information advertisement to users.

What is claimed is:

1. A computer-based system for delivering targeted information to a user of a product based on interests of the user, the system comprising:
a first computer-based device operating a rule-defining software for receiving rule-defining data;
a database for storing rules based on the rule-defining data;
a second computer-based device for detecting a product identifier encoding at least a webpage locator, and operating a web browser for displaying a webpage based on the webpage locator, the webpage having one or more page parts; and
a web server connected to the first and second computer-based devices and the database, for determining product data based on the product identifier, retrieving from the database user interest data corresponding to interests of the user, applying one or more of the rules to the product data and the user interest data, and modifying at least one of the page parts of the webpage based on the product data and the user interest data.

2. The computer-based system of claim 1, wherein the web server determines location data corresponding to a location of the second computer-based device, and the web server applies one or more of the rules to the location data for outputting information to the user based on a location of the user.

3. The computer-based system of claim 2, wherein the web server selects a store within a predetermined distance of the second computer-based device from a list of stores in the database, the selection being based on the product data and the location of the second computer-based device, and
the web server modifies at least one of the page parts of the webpage based on another product associated in the database with the product as being a complementary product and offered at the selected store.

4. The computer-based system of claim 1, wherein the product identifier encodes the product data which includes a lot identification code corresponding to a lot that included the product, a product identification code corresponding to a type of the product, and a unique item identification code that is uniquely associated with only the product and not any other product.

5. The computer-based system of claim 4, wherein the rule-defining data is based on at least one of the lot identification code, the product identification code, or the unique item identification code, and at least one of the page parts of the webpage are modified based on at least one of the lot identification code, the product identification code, or the unique item identification code.

6. The computer-based system of claim 1, wherein the rule-defining data defines a time period for outputting advertisement contents using the webpage, and at least one of the page parts of the webpage is modified during the time period.

7. The computer-based system of claim 1, wherein the product identifier encodes a landing webpage locator and the product data, and a code-scanning software of the second computer-based device is configured to decode and retrieve the landing webpage locator and the product data in response to image recognition of the label by a camera of the second computer-based device.

8. The computer-based system of claim 1, wherein the product identifier is a wireless communication device coupled to a product for wirelessly transmitting the product data and the webpage locator to the second computer-based device.

9. The computer-based system of claim 1, wherein the web server stores a user-tracking code on the second computer-based device for tracking web browsing activities of the user, and stores or updates a profile of the user based on the tracked web browsing activities, and wherein one or more of the rules are applied to information stored in the profile of the user.

10. The computer-based system of claim 1, wherein the web server receives data presentation criteria from the rule-defining software for indicating criteria for displaying advertisement contents using the second computer-based device and modifies at least one of the page parts of the webpage based on the data presentation criteria.

11. The computer-based system of claim 10, wherein the data presentation criteria requires displaying a first advertisement to a first group of users based on the rule-defining data and a second advertisement to a second group of users based on the rule-defining data, and the web server is configured to compare user feedback for the first advertisement and the second advertisement based on user selection of the page parts of the webpage.

12. A non-transitory computer storage medium storing instructions that when executed by a processor, cause the processor to perform a method for delivering targeted information to a user of a product, comprising the steps of:
receiving rule-defining data from a first-computer based device for indicating advertisement contents to be displayed based on user interests;
storing rules in a database based on the rule-defining data;
receiving product data and a webpage locator from a second computer-based device;
displaying a webpage based on the webpage locator;
retrieving or determining user interest data corresponding to an interest of the user;
applying one or more of the rules to the user interest data; and
adding or modifying a page part of the webpage based on the application of the one or more of the rules.

13. The non-transitory computer storage medium of claim 12, wherein the step of receiving the rule-defining data includes receiving location data corresponding to a location of the second computer-based device, and the step of adding or modifying the page part is based on the location of the second computer-based device.

14. The non-transitory computer storage medium of claim 12, wherein the step of receiving the rule-defining data includes receiving time data indicating a time period for adding or modifying the page part of the webpage, and the step of adding or modifying the page part of the webpage is performed during the time period.

15. A computer-based method for displaying dynamic information to a user of a product, comprising the steps of:
receiving rule-defining data from a first-computer based device for indicating advertisement contents to be displayed based on user interests and user location;
storing rules in a database based on the rule-defining data;
detecting a product identifier that encodes a webpage locator and product data corresponding to the product;
decoding and retrieving the webpage locator and the product data;
displaying a webpage on a second computer-based device based on the webpage locator;
retrieving user interest data corresponding to an interest of the user;
determining a location of the second computer-based device;
applying one or more of the rules to the user interest data and the location of the second computer-based device; and
adding or modifying a page part of the webpage based on the application of the one or more of the rules.

16. The computer-based method of claim 15, wherein the product data includes a lot identification code corresponding to a lot that included the product, a product identification code corresponding to a type of the product, and a unique item identification code that is uniquely associated with only the product and not any other product, and the rule-defining data is based on at least one of the lot identification code, the product identification code, or the unique item identification code.

17. The computer-based method of claim 15, wherein the method further comprises:
receiving data presentation criteria indicating criteria for displaying advertisement contents; and
modifying at least one of the page parts of the webpage based on the data presentation criteria.

18. The computer-based method of claim 17, wherein the data presentation criteria requires displaying a first advertisement to a first group of users based on the rule-defining data and a second advertisement to a second group of users based on the rule-defining data, and the web server is configured to compare user feedback for the first advertisement and the second advertisement based on user selection of the page parts of the webpage.

19. The computer-based method of claim 15, wherein the step of receiving the rule-defining data includes receiving time data indicating a time period for adding or modifying the page part of the webpage, and the step of adding or modifying the page part of the webpage is performed during the time period.

20. The computer-based method of claim 15, further comprising:
storing a user-tracking code on the second computer-based device for tracking web browsing activities of the user on the webpage; and
storing or updating a profile of the user based on the tracked web browsing activities, wherein the one or more rules is applied to the profile of the user, and the step of adding or modifying the page part of the webpage is based on the profile of the user.
